(19) United States
(12) Patent Application Publication
(10) Pub. No.: US 2022/0364252 A1
(43) Pub. Date: Nov. 17, 2022

(54) METHODS FOR MANUFACTURING METALLIC CUTTING EDGE THROUGH ELECTRODEPOSITION

(71) Applicant: BIC VIOLEX Single Member S.A., Anoixi (GR)

(72) Inventors: Christos AMPATIS, Anoixi (GR); Charalampos SCHIZAS, Anoixi (GR); Vasileios PAPACHRISTOS, Anoixi (GR)

(73) Assignee: BIC VIOLEX Single Member S.A., Anoixi (GR)

(21) Appl. No.: 17/658,865

(22) Filed: Apr. 12, 2022

Related U.S. Application Data
(60) Provisional application No. 63/182,226, filed on Apr. 30, 2021.

(51) Int. Cl. C25D 1/00; C25D 5/04; C25D 5/48; C25D 3/38

(52) U.S. Cl. CPC C25D 1/003; C25D 5/04; C25D 5/48; C25D 3/38; B26B 21/54

(57) ABSTRACT

A method of manufacturing a metallic cutting member, through electrodeposition, comprises moving a dispenser filled with a metal salt solution to a first printing position, depositing a metal onto a conductive or semi-conductive substrate via the dispenser until the deposited metal contacts the dispenser, and upon detecting that the deposited metal contacts the dispenser, moving the dispenser to a second printing position.

### CROSS-REFERENCE TO RELATED APPLICATIONS

This application claims the benefit of priority from U.S. Provisional Application No. 63/182,226, filed on Apr. 30, 2021, which is incorporated by reference herein in its entirety.

### FIELD

Various aspects of the present disclosure relate to methods and systems for manufacturing metallic cutting members, more specifically cutting edges, blade bodies, and/or blade supports through electrodeposition to produce 3D printed blade and/or blade edges using additive manufacturing.

### BACKGROUND

Traditional techniques for fabricating razor blades include exposing a metallic strip through heat treatment, to harden a metal, and grinding the hardened metal to form a wedge-shaped or bullet-shaped cutting edge. A ceramic coating is applied to the edge of the metal (e.g., through sputtering) to increase the edge's hardness. A final edge-etching step can be performed in a sputtering chamber to nano-sharpen the tip of the edge. During this process, the tip of the edge has a radius of about 50 nm. Such processes may be limited when fabricating features out of metal that are, for example, less than 1 um.

According to a traditional technique, alternative methods for fabricate a cutting edge (e.g., for a razor blade) include fabrication of a silicon wafer through the utilization of a standard lithography method. Alternative methods also include 3D printed polymer cutting edges, manufactured through the utilization of 2-photon-polymerization (2PP) technology, on a substrate that may include metal, ceramic, or polymer and it may be flat or extended. Such a surface may act as a base for a respective edge (e.g., as a blade body or a blade support). With 2PP technology, features having dimensions down to 200 nm can be fabricated out of polymeric material. An ultimate tip radius of approximately 1000 nm may be generated using traditional techniques. Such an edge may have a length of 1.2 mm and a width of 450 um such that many edge blades can be placed side by side to form a full-length blade edge of approximately 40 mm.

According to another traditional technique, a polymer cutting edge may be manufacturing by using a molding method where a template blade edge is used to create a mold and liquid polymer is poured into a mold cavity. The liquid polymer is cured and removed from the mold, resulting in a polymer edge. According to this technique, the ultimate tip radius may be approximately 1000 nm.

The background description provided herein is for generally presenting the context of the disclosure. Unless otherwise indicated herein, the materials described in this section are not prior art to the claims in this application and are not admitted to being prior art, or suggestions of the prior art, by inclusion in this section.

### BRIEF DESCRIPTION OF THE DRAWINGS

The accompanying drawings, which are incorporated in and constitute a part of this specification, illustrate various exemplary embodiments and, together with the description, serve to explain the principles of the disclosure. There are many aspects and embodiments described herein. Those of ordinary skill in the art will readily recognize that the features of a particular aspect or embodiment may be used in conjunction with the features of any or all of the other aspects or embodiments described in this disclosure. Embodiments of the present disclosure will now be described, by way of example only, with reference to the accompanying drawings in which:

FIG. 1 illustrates an exemplary cutting member of a blade, according to aspects of the present disclosure.

FIG. 2 illustrates an exemplary cutting member of a blade on a substrate, according to aspects of the present disclosure of the metallic cutting member printing setup.

FIG. 3A is a flow-chart for metallic cutting member printing using electrodeposition of locally dispensed ions, according to aspects of the present disclosure.

FIG. 3B illustrates a metallic cutting member printing setup, according to aspects of the present disclosure.

FIG. 4 illustrates a diagram of an additive micro-manufacturing system, according to aspects of the present disclosure.

FIG. 5 illustrates scanned electron microscopy (SEM) images of different ion tip apertures, according to aspects of the present disclosure.

FIG. 6A is a flow-chart for 3D template assisted electrodeposition steps for metallic cutting member fabrication, according to aspects of the present disclosure.

FIG. 6B illustrates 3D template assisted electrodeposition steps for metallic cutting member fabrication, according to aspects of the present disclosure.

FIG. 7 illustrates a 3D printed cutting member with hard and lubricating coatings, according to aspects of the present disclosure.

FIG. 8 illustrates a diagram of an electrolytic cell for electrodeposition of a metal, according to one aspect of the present disclosure.

FIG. 9 illustrates diagrams of categories of electrodeposition 3D printing, according to aspects of the present disclosure.

FIG. 10 illustrates diagrams of meniscus-confined electroplating/electrodeposition, according to aspects of the present disclosure.

FIG. 11 illustrates diagrams of an automated force-controlled electrochemical 3D printing process, according to aspects of the present disclosure.

FIG. 12 illustrates diagrams showing local dispensing of metal ions in liquid, according to aspects of the present disclosure.

FIG. 13 illustrates diagrams of electrohydrodynamic redox printing, according to aspects of the present disclosure.

FIG. 14 illustrates 3D template assisted electrodeposition, according to aspects of the present disclosure.

### SUMMARY

Aspects of the disclosure include:

A method for manufacturing a metallic cutting member, such as a cutting member, through electrodeposition, the method including moving an AFM (Atomic Force Microscopy) dispenser filled with a metal salt solution to a first printing position, depositing a metal onto a conductive or semi-conductive substrate via the dispenser until the deposited metal contacts the dispenser, and upon detecting that the deposited metal contacts the dispenser, moving the dispenser to a second printing position.

A method of manufacturing a metallic cutting member, such as a cutting member through electrodeposition, the method including depositing a positive tone photoresist on a conductive or semi-conductive substrate, applying a two-photon polymerization according to a cutting member shape defined by a 3D computer aided model of the metallic cutting member to the photoresist, applying a developer to the positive tone photoresist previously exposed to two-photon polymerization to leave hollow an area corresponding to the cutting member shape, performing electrodeposition to deposit a metal in the hollow area, to form the metallic cutting member, and removing the deposited metallic cutting member from the photoresist.

### DETAILED DESCRIPTION

The present disclosure relates to methods and systems for forming thin metal razor blades for use in a shaver, particularly for manufacturing metallic cutting members through electrodeposition, such as cutting edges. The techniques disclosed herein may apply an additive method to construct a razor blade by a) 3D printing in which metal grows voxel-by-voxel using a localized and controlled in 3D space electrodeposition technique or b) applying electrodeposition inside a micro-mold 3D printed via 2PP with a shape corresponding to a metallic cutting member. The techniques disclosed herein may be used to precisely control the manufacturing of a cutting member, and may result in a cutting member that precisely meets defined criteria.

Both the foregoing general description and the following detailed description are exemplary and explanatory only and are not restrictive of the features, as claimed. As used herein, the terms “comprises,” “comprising,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Additionally, the term “exemplary” is used herein in the sense of “example,” rather than “ideal.” It should be noted that all numeric values disclosed or claimed herein (including all disclosed values, limits, and ranges) may have a variation of +/−10% (unless a different variation is specified) from the disclosed numeric value. Moreover, in the claims, values, limits, and/or ranges means the value, limit, and/or range +/−10%. Furthermore, the terms “about” or “approximately” are defined herein as encompassing a variation of +/−10% from the disclosed numeric value (unless a different variation is specified).

Embodiments of the present disclosure related to methods and systems for forming one or more blades (e.g., for a shaver). As applied herein, the final version of a blade edge tip is referred to as an “ultimate tip.” The methods and systems disclosed herein may help to form one or more blades using localized electrodeposition techniques to fabricate metallic cutting members. As applied herein, a cutting member may refer to a blade edge or tip (e.g., ultimate tip), a blade body, and/or a blade support, or the like. A cutting member that is or includes a blade support may correspond to a unitary structure that includes a blade support, blade body, blade edge. The disclosure provided herein includes examples of a blade edge for simplicity. However, it will be understood that any of the techniques, systems, and materials disclosed herein can apply to manufacturing any metallic cutting member (e.g., a blade edge tip, a blade body, and/or a blade support), and not just a blade edge). The methods and systems disclosed herein may help to form a blade using one or more additive methods that allow fabrication of a metallic cutting member, such as a metallic cutting edge instead of a polymer. In comparison to a polymer member, a metallic cutting member may be more durable and may be further enhanced with ceramic and/or lubricating coatings. As applied herein, “additive methods” may reference technologies that grow three-dimensional objects by building one superfine layer at a time or one 3-dimensional (3D) object/pixel known as voxel, at a time. Each successive layer or voxel may bond to the preceding layer, or voxel, respectively.

Additive methods may include manufacturing techniques such as plating, stereolithography and 3D printing that may allow manufacturing of small features. Features down to 200 nm may be fabricated out of polymer using 2-photon polymerization (2PP) or two-photon lithography based additive manufacturing techniques. Additive manufacturing techniques like Lithographic based Metal Manufacturing LMM and Lithographic based Ceramic Manufacturing (LCM) may be used to obtain features of metal and ceramic, respectively, down to 50 um. By using such additive manufacturing techniques, a 3-dimensional (3D) object may be build up from small volume elements (e.g., voxels), of material that are successively added to each other until an entire object is formed.

Implementations of the disclosed subject matter facilitate manufacturing a metallic cutting member, such as a cutting edge having a certain shape. For example, a cutting edge may have a certain shape and an ultimate tip having a radius of less than 1000 nm. Techniques disclosed herein provide a metallic cutting member manufactured using additive methods instead of subtractive manufacturing (e.g., micromachining, laser or focused ion beam milling, etc.). In some embodiments, methods are disclosed herein that do not use any form of subtractive manufacturing to form a metallic cutting member. In comparison to polymers, the metallic cutting members disclosed herein may provide increased toughness and, due to conductive properties, the metallic cutting members may allow application of ceramic hard coatings via sputtering and may also allow ultimate tip nano-sharpening.

Implementations of the disclosed subject matter include localized electrodeposition (e.g., electroplating or electrochemical (EC) reduction) of pure metals on a conductive or semi-conductive substrate, through an additive method and voxel-by-voxel, at a sub-micron level.

According to implementations of the disclosed subject matter, techniques for manufacturing one or more cutting members, such as razor blades, from a metallic material and a functional metallic cutting member such as a razor blade, are disclosed. As disclosed herein, a cutting member may refer to a blade edge or tip (e.g., ultimate tip), a blade body, and/or a blade support, or the like.

The techniques may include providing a CAD model of a cutting member, providing at least one conductive or semi-conductive substrate on which at least one metallic cutting member is formed through localized electrodeposition. The localized electrodeposition may be either MCED, electroplating of locally dispensed ions in liquid or EHD-RP, or 3D template assisted electrodeposition where the 3D template (mold) may be manufactured using 2PP.

The shape of the metallic cutting member may include an edge with two facets and a tip, a gothic arch, a roman arch, or one or more undercuts. The cutting member's edge tip radius may be less than 1 um.

The mechanical and cutting properties of the cutting member's edge may be improved by the deposition of hard coatings through sputtering and nano-sharpening via etching inside a sputtering chamber.

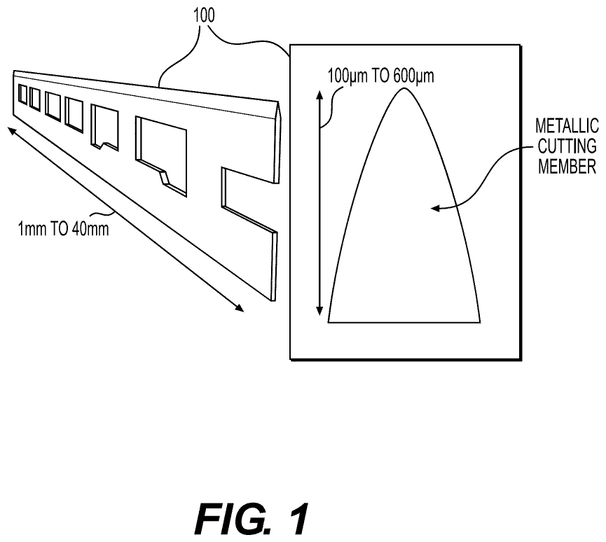

FIG. 1 shows a metallic cutting member 100 including an edge of a blade extending 100 um to 600 um from the ultimate edge tip. Each metallic cutting member 100 (e.g., of a plurality of metallic cutting members including their respective edges) may have a length of 1 mm to 40 mm, a height of 100 um to 600 um, a tip radius of less than 1 um, and a shape that may have two facets and a tip, a gothic arch, a roman arch, or may have one or more undercuts.

The metallic cutting member 100 may be developed on any conductive or semi-conductive substrate. The substrate may be steel, silicon, silver, gold, copper, nickel, nano-crystalline nickel, iron, or any other pure metal. The substrate may also include a polymer or ceramic with a conductive coating such as an ITO coated glass.

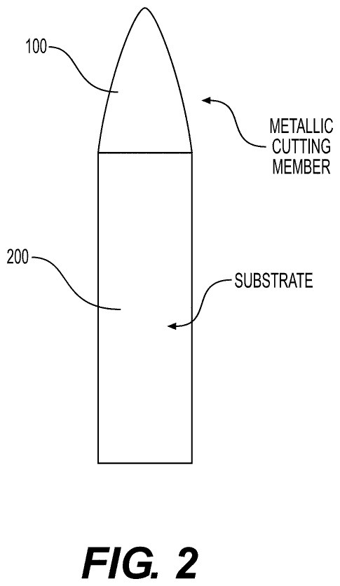

The substrate may be shaped like a un-grinded flat razor blade, a un-grinded razor bent blade, or a razor blade support. The substrate roughness (e.g., mean roughness/average roughness (Ra)) may be approximately in the range of 1 nm to 200 nm. The cutting member may be 3D printed on the un-grinded blade strip. As shown in FIG. 2, the metallic cutting member 100 may be developed on a conductive or semi-conductive substrate 200. The surface roughness of the substrate may be 1 nm to 200 nm.

The metallic cutting member 100 may be manufactured in accordance with one or more techniques disclosed herein. Localized electrodeposition 3D printing may be used to manufacture arbitrary metallic structures in an additive fashion for manufacturing a metallic cutting member 100. Any of the techniques for localized electrodeposition 3D printing disclosed herein may be applied. For example, the electrodeposition of locally dispensed ions in liquid with FluidFM technique may be applied. Alternatively, 3D template assisted electrodeposition (electrodeposition inside micro-molds) may be applied, as described in further detail herein.

Electrodeposition of locally dispensed ions in liquid with FCEP (Force Controlled Electroplating) (e.g., with the FluidFM technique) are disclosed herein. Although some techniques disclosed herein use copper (Cu) as the material of the metallic cutting member, the techniques may be applied to any other material that can be electroplated. Such materials include, but are not limited to silver, gold, copper, nickel, nano-crystalline nickel, iron, or the like or potentially a combination thereof.

The 3D printing techniques disclose herein provide voxel-by-voxel metal printing. A process for such printing is based on micro-channeled AFM (Atomic Force Microscopy) cantilevers with an aperture at the tip apex (e.g., FluidFM). The cantilevers may be used as a local source of metal ions in an electrochemical cell, leading to a localized electroplating reaction directly under the tip aperture.

A CAD model of the cutting member to be printed may be provided and loaded in a control system and may include information of the positions of each voxel that correspond to the cutting member shape to be printed. The conductive or semi-conductive substrate may be inserted and aligned on the printing chamber on which the metallic cutting member 100 is printed.

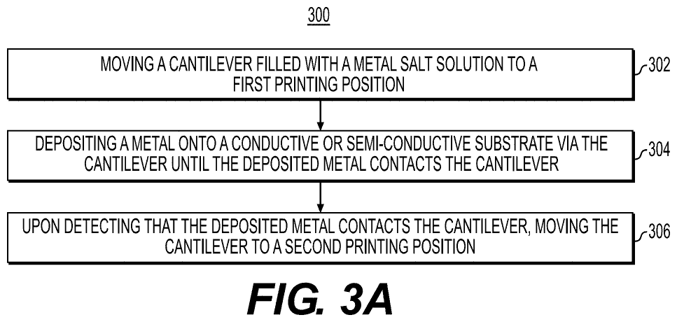

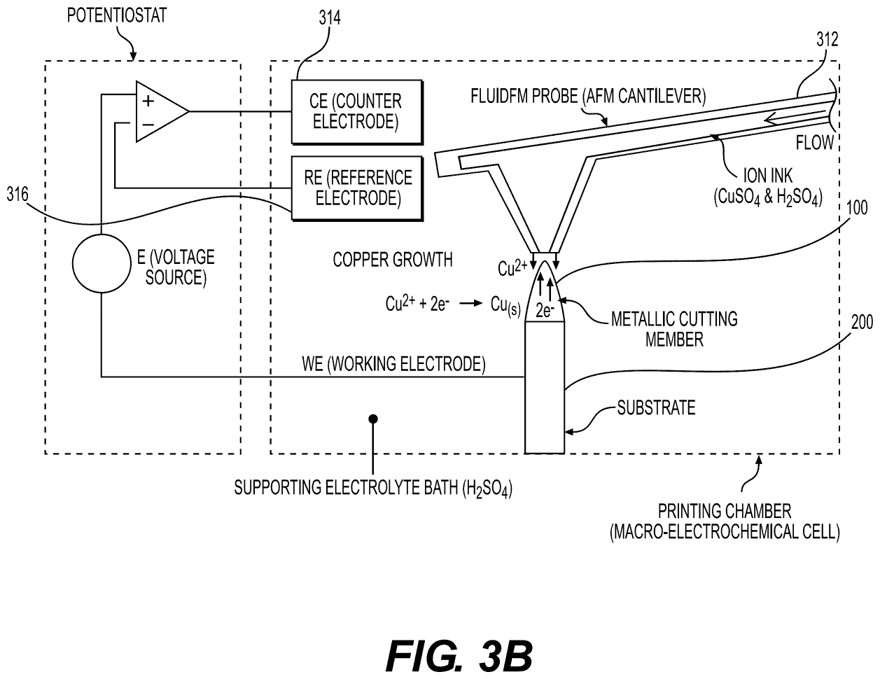

FIG. 3A is a flow-chart 300 for manufacturing a metallic cutting member printing through electrodeposition. At 302, a dispenser filled with a metal salt solution may be moved to a first printing position. The dispenser may be, for example, a cantilever. Although the disclosure herein recites a cantilever, it will be understood that any applicable dispenser, and not just a cantilever, may be used to implement techniques disclosed herein with reference to a cantilever. From the cantilever, a metal may exit in ionic form and it deposits onto the substrate as metal. At 304, a metal may be deposited onto a conductive or semi-conductive substrate (e.g., conductive or semi-conductive substrate 200 of FIG. 2) via the cantilever until the deposited metal contacts the cantilever. Particularly, while the metal is deposited the metal deposit grows until contacting the cantilever. The metal may be deposited using the metal salt solution of 302. At 306, upon detecting that the deposited metal contacts the cantilever, the cantilever may be moved to a second printing position. The metallic cutting member may be formed by repeating the steps in flow-chart 300, as further discussed herein.

FIG. 3B shows an electrochemical deposition setup. As shown, the FluidFM cantilever 312 (inset) is immersed in a three-electrode electrochemical cell containing a quasi-reference electrode 316 (e.g., a silver quasi-reference electrode or one with any other applicable metal/material) and a counter electrode 314 (e.g., a platinum counter electrode or one with any other applicable metal/material). The FluidFM cantilever 312 (inset) is immersed inside the printing chamber which is a macro-electrochemical cell. The cantilever 312 may be filled with a metal salt solution (e.g., CuSO4 or other applicable material) whose flow from the aperture of the FluidFM probe is precisely controlled by a pressure controller. The pressure may control the flow of the metal salt solution. The flow in combination with the size of the AFM cantilever tip aperture may control the corresponding voxel size. The pressure controller may facilitate a range of pressures between approximately 1 mbar and 2000 mbar, although other suitable pressures also are contemplated. In this configuration, the FluidFM probe tip is used as a local source of metal Cu2+ ions in a macro-electrochemical cell containing a supporting electrolyte (H2SO4). If the tip is approached to a surface having a sufficiently high cathodic potential, the metal Cu2+ ions exiting the aperture are reduced locally, resulting in confined metal electrodeposition under the FluidFM tip. The deposit size is confined by the diffusion profile of the metal ions. This technique is not limited to depositing Cu2+ ions as the electrolytes may include other metal ions that can be deposited in accordance with this method.

The diagram of a metallic cutting member printing setup in FIG. 3B shows a hollow FluidFM cantilever 312 being used as a local source of metal Cu ions in a liquid environment. The probe is positioned and its deflection is monitored by an AFM head using a standard optical beam deflection method (e.g., AFM). A pressure controller is used to control the flow of metal ions from the probe aperture and a potentiostat is used to polarize the substrate such that the metal ions are reduced locally under the probe. The system components are synchronized such that 3D printing may be automated.

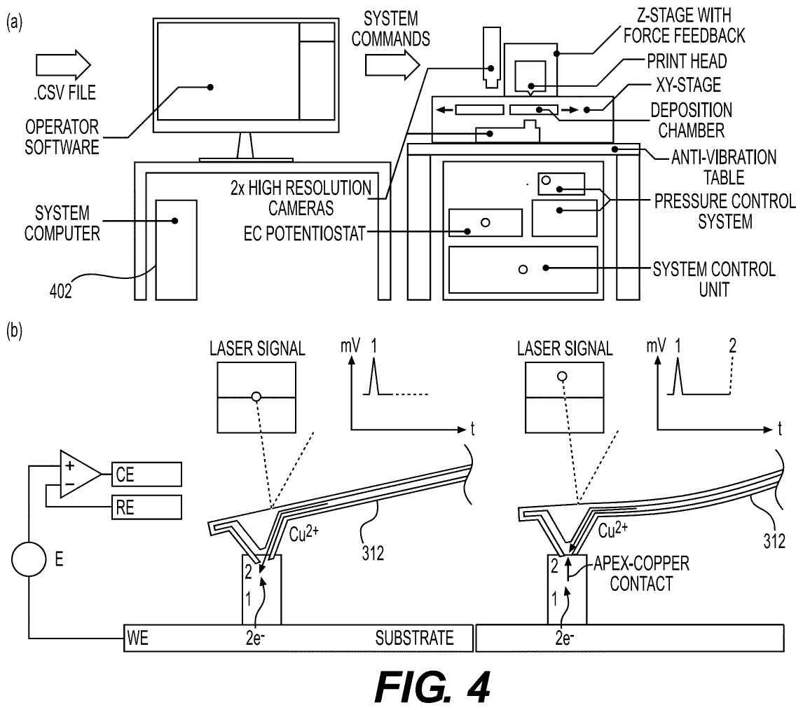

FIG. 4 shows a process for voxel-by-voxel 3D printing. In a simplified example of one voxel on top of the other, a current printing position is approached by a probe, as shown at FIG. 4B, when the deposition process is started. The resulting metal deposit subsequently grows and eventually touches the probe, which may be immediately recognized via the deflection signal of the AFM cantilever 312. When the deflection signal is registered, the system moves the cantilever 312 to a new position where the fabrication process continues. The printing process is structured in a layer-by-layer fashion and the resolution is determined by the minimal spot size that may be deposited under the aperture of the AFM probe.

In FIG. 4A's additive micro-manufacturing system, a system computer 402 sends commands to the system control unit shown on the right. On the right, the system control unit governs the printing process using an embedded controller. The FluidFM probe sits on the printing head and is moved in the EC deposition chamber by the z-stage. A microfluidics control system regulates the electrolyte flow through the cantilever aperture. The diagram shown in FIG. 4B is a representation of the printing process. Cu2 [symbol] (Cu2+) ions are locally injected in the EC cell through the cantilever aperture in close proximity (e.g., Δz ¼ 500 nm) of a growing structure (WE), these ions are electrochemically reduced to Cu0 on the metal surface, forming the printed voxel. When the reduction front reaches the AFM cantilever 312, the latter is deflected (e.g., using optical beam deflection), automatically triggering the positioning to the next location. As disclosed herein, WE, CE, and RE indicate the working electrode, counter electrode, and reference electrode, respectively.

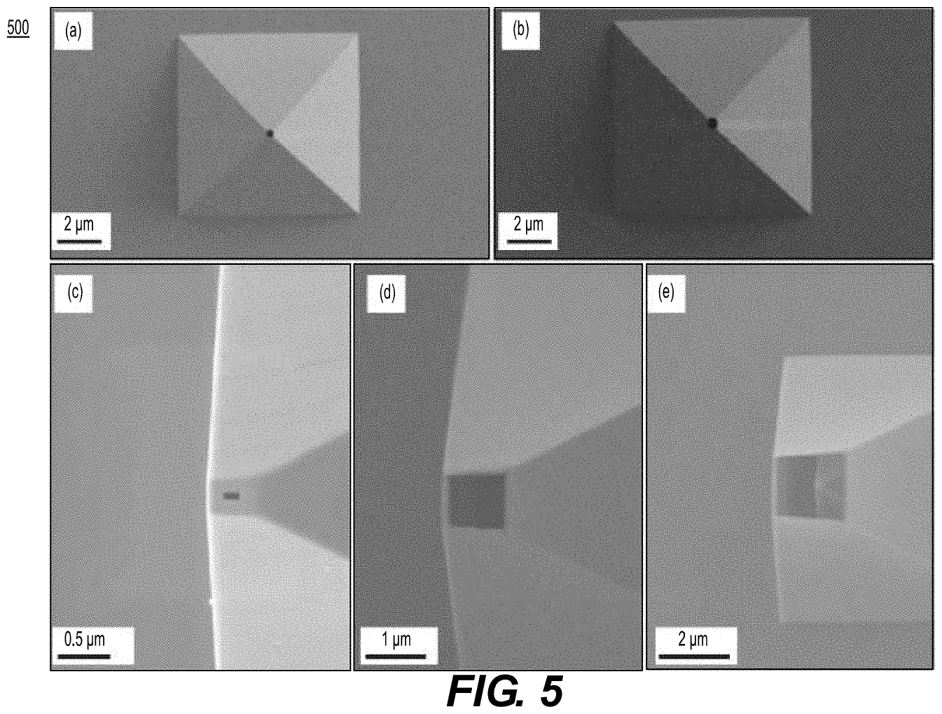

According to an implementation, an AFM cantilever ion tip fabrication technique may be used. AFM cantilevers may be produced with an embedded microchannel connecting the hollow pyramidal tip on one side and a macro reservoir on the other side. Such micro-channels may be obtained either by etching a sacrificial polysilicon layer between two layers of Si3N4 according to a batch processes. The standard section of the microchannel is of 20 μm×1 μm, whereas the pyramid is 10 μm×10 μm×7 μm with a circular aperture at the apex either of 300 nm or of 500 nm diameter, as shown in FIG. 5. Alternatively, for apex apertures of different sizes, closed probes having no aperture at the apex may be used via FIB milling. In this case, the probes may be mounted in a custom probe holder and coated with a carbon layer (e.g., 18-nm-thick) using a carbon coater (e.g., CCU-010 Carbon Coater) before milling by a FIB-scanning electron microscope (SEM) device (e.g., Nvision 40) with SEM software (e.g., SmartSEM software). The milled face of the pyramidal probe may be aligned in parallel with the FIB-beam equipped with a gallium ion source. Subsequently, the probes may be milled with an acceleration voltage of 30 kV at milling currents varying from 10 pA up to 8 pA, depending on a desired opening. The active milling process may be followed in live SEM mode and may be terminated when a desired opening size is reached. After the milling process, the probes may be glued onto a dedicated printing holder (e.g., Exaddon AG). AFM approaches may be performed in contact mode in a standard optical beam deflection technique.

FIG. 5 shows SEM images 500 of different ion tip apertures. The top view of FIG. 5A is a 300 nm aperture and at FIG. 5B is a 500 nm diameter aperture, obtained by contact lithography. The top view of at FIG. 5C is a 100 nm aperture, at FIG. 5D is a 1 μm aperture, and at FIG. 5E is a 2 μm side-square aperture, obtained by FIB milling of closed pyramidal probes.

To build a blade cutting member, an ultimate tip radius less than approximately 1000 nm may be achieved by utilizing an AFM cantilever ion tip aperture of less than 500 nm.

After the printing process of the cutting member is completed, the sample may be removed from the printing chamber to follow a separate post processing of cutting member coating to further improve the cutting member cutting performance.

As discussed, a 3D template assisted electrodeposition (electrodeposition inside micro-molds) may be used for metallic cutting member manufacturing, such as cutting edge manufacturing. A mold for such manufacturing may be fabricated using a 2PP 3D printer.

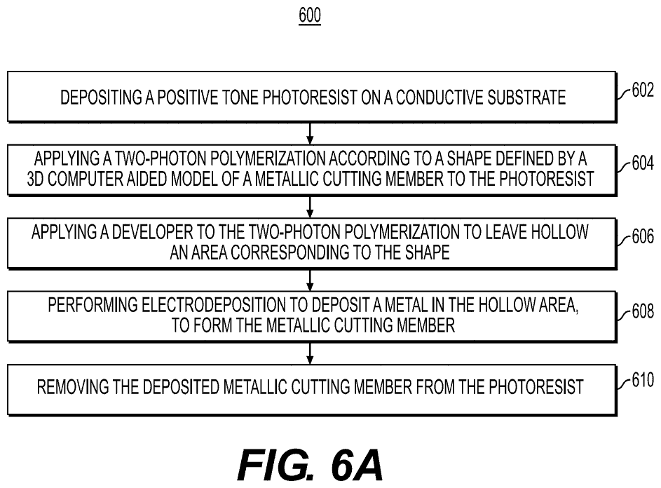

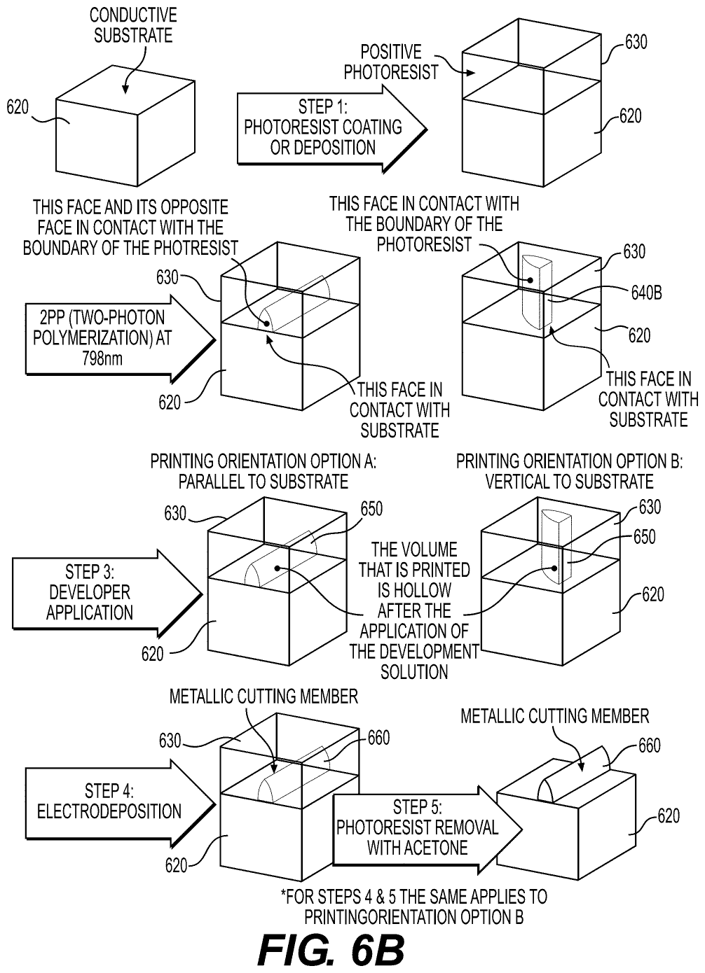

FIG. 6A is a flow-chart 600 for manufacturing a metallic cutting member through electrodeposition. At 602, a positive tone photoresist may be deposited on a conductive or semi-conductive substrate. At 604, a 2PP may be applied within the photoresist according to a cutting member shape defined by a 3D computer aided model of a metallic cutting member. At 606, a developer may be applied to the 2PP to leave hollow an area corresponding to the cutting member shape. At 608, electrodeposition may be performed to deposit a metal in the hollow area, to form the metallic cutting member. At 610, the deposited metallic cutting member may be removed from the photoresist.

FIG. 6B shows a metallic cutting member manufacturing technique using 3D template assisted electrodeposition, as described in flow-chart 600 of FIG. 6A. 3D template assisted electrodeposition may be performed as a combination of electrodeposition and two-photon lithography configured to create 3D micro-architectures. The localization of the chemical reaction in the focal point of the laser in two-photon lithography allows for the creation of 3D templates with submicron accuracy and almost no geometrical restrictions, while electrodeposition offers a high amount of control over the deposits' microstructure, composition, and internal stress.

Nanocrystalline nickel NC—Ni may be used as the material of the blade cutting member, however this technique for manufacturing a blade cutting member may be potentially applied to any other material that can be electroplated including, but not limited to, silver, gold, copper, nickel, nanocrystalline nickel, and iron, and potentially a combination thereof.

FIG. 6B shows the steps for fabricating a metallic cutting member 100 using 3D template assisted electrodeposition. As shown, a first step may include deposition of a positive tone photoresist 630 (photopolymer) on the conductive or semi-conductive substrate 620 of the cutting member, utilizing any method of deposition including spin coating, dispensing photoresist 630 on substrate 620, or immersing the substrate 620 on the photoresist 630. The substrate 620 may be the same as or similar to substrate 200 of FIG. 2.

A second step may include applying a two-photon polymerization 640 of the 3D CAD model of the cutting member on the photoresist 630. The polymerization 640A/640B of the 3D model of the cutting member to be printed may have at least one face in contact with the substrate 620 of the cutting member and at least on face on the outer face of the photoresist 630. FIG. 6B shows two example implementations where the polymerization 640A/640B of the 3D model of the cutting member has one face in contact with the substrate 620 of the cutting member and at least one face on the outer face of the photoresist 630. As shown, the orientation of the 2PP printing may be such that the cutting member may be vertical (e.g., polymerization 640B) or parallel (e.g., polymerization 640A) to the substrate 620. A vertical cutting member orientation (e.g., polymerization 640B) may be a top and bottom facing orientation and a parallel cutting member orientation (e.g., polymerization 640A) may be a side facing orientation that is perpendicular to the top and bottom facing orientations.

A third step may include application of developer (solvent) to leave hollow the printed area corresponding to the cutting member 3D geometry. As a result of positive tone photoresist 630, material is degraded by laser beam light (e.g., 2-photon polymerization laser beam light) and the developer dissolves away the regions that were exposed to the laser beam light, leaving hollow the CAD model exposed to the laser beam light and thus creating a micro-mold of the cutting member to be filled with metal by electrodeposition. The hollowed space 650 corresponding to the shape may remain after application of the developer and/or laser beam light.

A fourth step may include the electrodeposition, as disclosed herein. A three-electrode setup with the substrate 620 as the working electrode may be used. The metallic cutting member 660 may be formed as a result of the electrodeposition.

A fifth step may include removal of the photoresist 630 (mold) via sonication in a solvent, more specifically in acetone, and collecting of the sample from the electrochemical cell. Hence, the deposited metallic cutting member is removed from the photoresist.

According to an example, a method to fabricate micro-springs using nanocrystalline nickel (NC—Ni) may be used to form the blade cutting member. However, a method for manufacturing a blade cutting member may be applied to any other material that can be electroplated including silver, gold, copper, nickel, nanocrystalline nickel and iron, or the like or potentially a combination thereof.

According to an example, a Nanoscribe Professional GT is used to create templates for a cutting member. The structure is written with a 63× magnification objective through Zeiss immersion oil through a 120 um thick ITO-coated glass slide into AZ9260 positive-tone photoresist. The glass slide can be first cleaned for 5 min in a 100 W O2-plasma, followed by a dehydration bake of 15 min at 160° C. The photoresist can then be spin coated onto the ITO slide with a Sawatec SM-150. A first spin coat step can be done at 2400 rpm for 60 s followed by a soft bake of 4 min at 110° C. To achieve the desired thickness, a second spin coat can be performed at 2100 rpm for 60 s and 8 min of soft bake at 110° C. Using Nano-scribe Software ‘Describe’, the 3D CAD design of the cutting-member can be sliced vertically, hatched laterally and can be exposed with a laser power of 11 mW and a laser speed of 9000 um s-1. Subsequently, the specimen can be developed in 1:4 AK400 Developer/H2O for 45 min and cleaned in distilled water for 15 min. Next, electrodeposition can be carried out using a three-electrode setup with a soluble nickel counter electrode, an Ag/AgCl reference electrode in 3 M KCL solution, and the ITO coating of the glass slide becomes the working electrode. The electrolyte can be composed of 1.19M nickel sulfamate, 0.3M nickel chloride, 0.75 M boric acid 0.19M saccharine and 0.04 mM sodium dodecyl sulfate. The chemicals Ni(SO3NH2)2(98%), NiCl2(99%), H3B03(99%), C7H5NO3S (99%), and CH3(CH2)11Na (99%) from SIGMA Aldrich can be used without further refinement. The electrodeposition setup can be controlled by a Metrohm PG-Stat202 and deposition can be carried out in potentiostatic mode at 60° C. without agitation and a voltage of −1.2 V vs Ag/AgCl. Deposition time can be 60 min to ensure a large overgrowth is produced. The sample can be subsequently removed from the electrochemical cell and can be inserted in a sonicated bath with acetone to remove the photoresist and the ITO coated glass substrate, leaving behind the metallic cutting member 100 out of nc-nickel material. The metallic cutting member ultimate tip radius is less than 1000 nm with this experiment.

According to an implementation, the metallic cutting member 100 may be post processed. As the material of the 3D-printed member is pure metal (i.e., copper, nickel, chromium) it can be sputtered with the standard sputtering process to achieve the desired hard coating on the member to increase its hardness. Similar to a standard razor manufacturing process, after hard coating in the sputtering chamber, a nano-sharpening step via etching may be also applied to further shape an edge tip. One or more lubricating coatings (e.g., a polytetrafluoroethylene coating) may also be applied.

The dispenser based techniques disclosed in FIGS. 3A-5 and the 2PP based techniques disclosed in FIGS. 6A-6B are linked such that they are both based on electrodeposition. In the first dispenser based techniques the electrodeposition is localized voxel by voxel controlled (via 3d printing) whereas in the second 2PP based techniques the electrodeposition is taking place inside a cavity (e.g., mold) that has the shape of the cutting member.

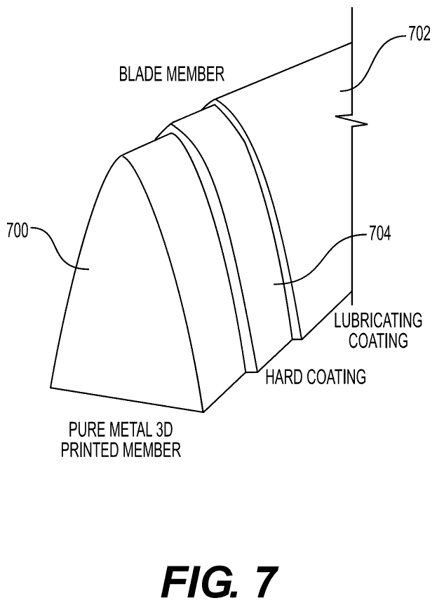

FIG. 7 shows a 3D printed cutting-member 700 (e.g., a cutting edge) with a hard coating 704 and a lubricating coating 702. The hard coating 704 and/or the additional coatings may prevent direct contact of the skin with the core of the pure metal member (e.g., nickel, copper, etc.), during use. This may prevent or mitigate dermatological issues.

### Further Discussion of Electroplating/Electrodeposition Used in Exemplary Embodiments

Electrodeposition (e.g., electroplating) may be used to apply a metal coating on a solid substrate, for example to form a metal cutting member for a razor, as disclosed herein. The coating may be applied through the reduction of cations of a given desired metal on the substrate per Equation 1 below. Electrodeposition may be used to improve surface qualities such as resistance to abrasion and corrosion, reflectivity, appearance, electrical conductivity, magnetic layers, or the like.

M^{Z+}+ze⁻ [symbol] M (1)

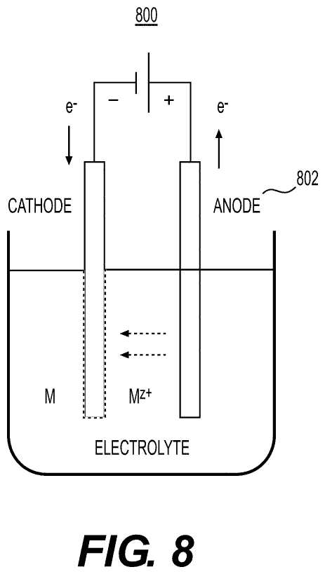

In reference to Equation 1 above, the electrodeposition process in which z electrons (e−) are provided by an external power supply can accomplish the reduction of metal ions M^{Z+}. An electrochemical cell for electrodeposition may include three components: two electrodes (a cathode and an anode) and an electrolyte (e.g., a reference electrode). For an electrolytic cell for electrodeposition, the electrolyte may be a solution of water or other solvents that includes dissolved ions of the metal to be deposited. The reduction of cations may take place at the cathode (i.e., negative electrode) and, accordingly, the cathode may coated. The anode (i.e., positive electrode) may be an inert conductive material or a block of the same metal that is used for the coating to replenish the electrolyte ions that have already been plated out during the electrodeposition process. An external electrical potential may be applied to overcome the reversible cell potential and produce the intended chemical reaction that would not otherwise occur spontaneously. FIG. 8 illustrates a diagram of an electrolytic cell 800 for electrodeposition of a metal. In the example shown in FIG. 8, the anode 802 is not of the same metal as metal M. Accordingly, the metal M ions may not replenish once they have been deposited. The electrolytic cell may be similar to a galvanic cell acting in reverse.

According to implementations of the disclosed subject matter, local electrodeposition 3D printing techniques may be applied. Local electrodeposition or electrochemical (EC) reduction techniques may be implemented by filling a printing nozzle (e.g., a pipette) with a solution containing a metal salt to bring it as close as possible to a biased conductive substrate. The biased conductive substrate may be connected as working electrode (WE). The solution may be injected, thereby inducing a confined metal plating as a result of the vicinity of the nozzle with the working electrode. Different protocols may be implemented using such local electrodeposition or EC techniques. These include: meniscus-confined electroplating (MCED), electrohydrodynamic redox printing (EHD-RP). Additional protocols are based on confined electrodeposition in liquid and include two techniques: a) force-controlled electroplating based on the localized delivery of metallic ions through hollow atomic force microscope (AFM_cantilevers in solution (FluidFM), and b) scanning ion conductance electroplating based on the same principle but relying on glass capillaries in scanning ion conductance microscope (SICM).

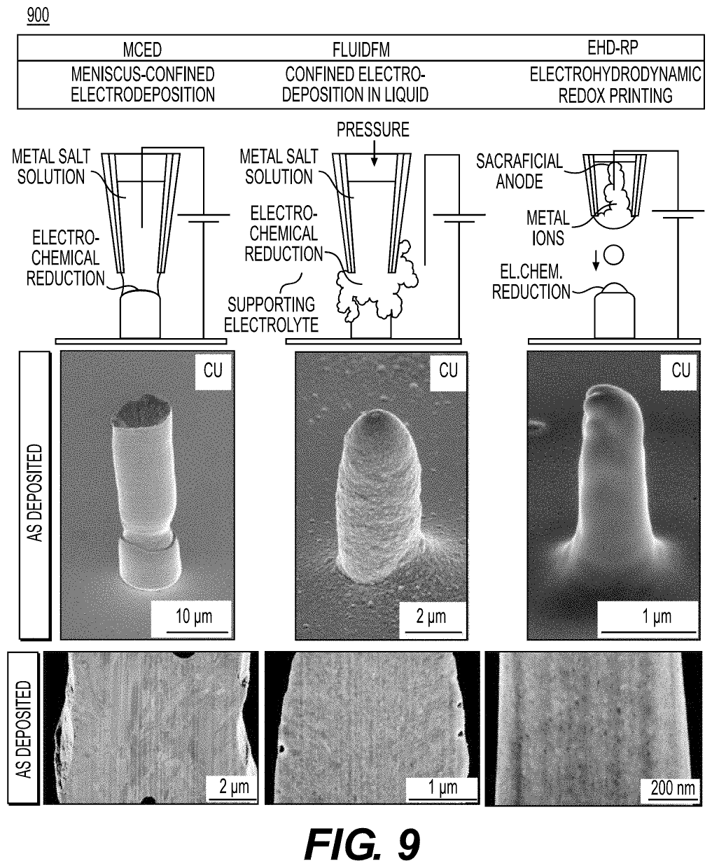

FIG. 9 shows three categories of micro-scale additive manufacturing 900 via electrodeposition. The first is a Meniscus-confined electrodeposition (MCED), the second includes confined electrodeposition in liquid with AFM cantilever-nozzle feedback (FluidFM), and the third is Electrohydrodynamic redox printing (EHD-RP). As shown in FIG. 9, the three categories of electrodeposition 3D printing are performed in accordance with the principles described herein to generate the as deposited printed pillars. The microstructures corresponding to each of the MCED, Fluid FM, and EHD-RP are shown in FIG. 9.

These electrochemical methods (MCED, FluidFM, EHD-RP) use different approaches to localize growth, but all use the electrochemical reduction of metal ions and deposit dense and crystalline metals.

MCEP may be performed in an atmosphere with controlled humidity. During an MCEP process, a glass pipette containing a given metal ion solution and equipped with a counter electrode (CE) may be moved towards a WE until a meniscus is formed between them. An EC cell reduction may take place inside the meniscus, forming a narrowed metal deposit that can be interpreted as a “voxel”. Accordingly, metal wires or other objects may be produced and may eventually branch out in 3D structures. The wires obtained may have a diameter smaller than an aperture diameter typically in the range between 100 nm and 250 nm. The metals, copper, and platinum may be electroplated. A feedback for the pipette approach may be implemented using MCEP by taking advantage of the EC current, once the meniscus is established. Additionally, parallelization to enlarge the printed area by utilizing nozzle arrays may also be implemented.

To localize the electroplating reaction, meniscus-confined electroplating may be implemented using dispensers (e.g., glass pipettes) to confine the electroplating solution to a specific area on the substrate.

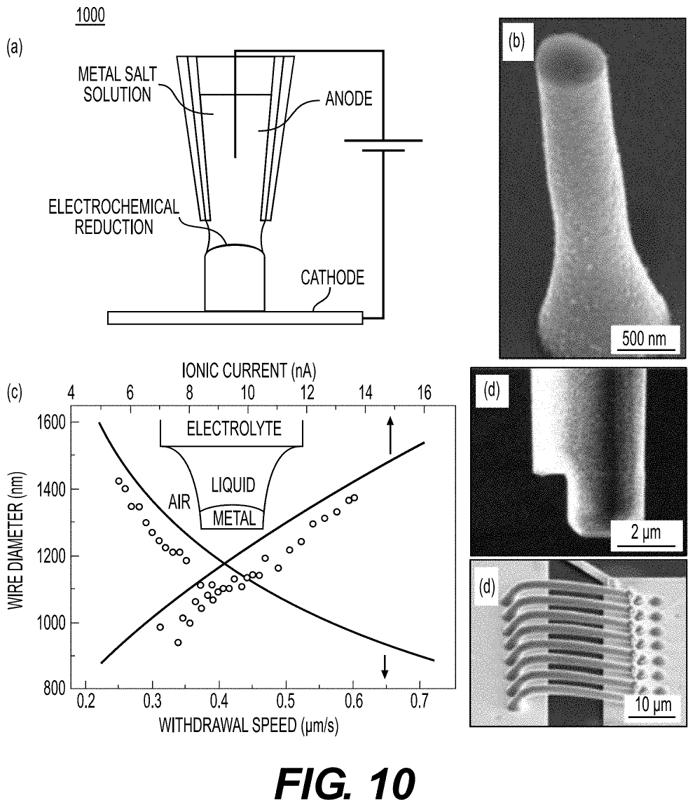

FIG. 10 shows meniscus-confined electroplating 1000. A nanopipette filled with a metal salt solution may be brought close to or in contact with a conductive substrate. A liquid meniscus may form between the pipette and the substrate upon contact with the electrolyte, as shown in FIG. 10. To initiate electrochemical reduction, the substrate may be negatively polarized in relation to a counter electrode placed in the pipette. The liquid meniscus may define the lateral extension of the electrochemical reaction, resulting in nucleation and growth of the metallic deposit. The controlled retraction of the pipette may promote the 3D growth of a metal wire or other object.

As shown in FIG. 10A, a micropipette filled with a metal salt solution and containing a wire electrode may be brought proximate to or in contact with a conductive surface. Upon contact with the substrate, a liquid meniscus may be formed. The application of a suitable potential between the wire electrode and the substrate may initiate the electrochemical reduction of the metal ions in the area confined by the meniscus. The linear retraction of the pipette may build a wire-like structure. FIG. 10B, shows a scanning electron microscopy (SEM) image of a copper pillar fabricated by meniscus-confined electroplating. FIG. 10C shows a graph that compares the influence of a withdrawal speed and the ionic current on the obtained wire diameter. As shown, slower withdrawal or a higher current result in bigger wire/object diameters. FIG. 10D shows that a customized pipette opening is required for the deposition of horizontal wires. The top of FIG. 10D shows a glass pipette modified by focused ion beam (FIB) milling to facilitate control of horizontal menisci. The bottom of FIG. 10D shows copper wire bonds fabricated by meniscus-confined electroplating.

In reference to FIG. 10, glass pipettes with micrometer to sub-micrometer wide apertures may be used to deliver the electrolyte solution. A counter electrode, such as a metal wire mounted inside the pipette and connected to a potentiostat, may be used to control a corresponding electrochemical reactions. Controlled wire fabrication may require retraction of the pipette at appropriate speeds to avoid breaking the meniscus. Because a feedback mechanism may not be available, the retraction velocity may be calibrated in accordance with FIG. 10C. An ionic current may be observed for a controlled approach to the substrate where a sharp increase in the current indicates contact with the substrate. As part of an electrodeposition process, a conductive or semi-conductive substrate 200, as shown in FIG. 2, may be required. The use of a liquid meniscus may confine the electroplating reaction. Accordingly, the corresponding wire thickness may depend primarily on the meniscus size, which can be as small as half the opening diameter of the pipette or micropipette used. In accordance with this technique, a solid vertical nanowires as thin as 100 nm may be fabricated. Establishing a stable liquid bridge under a nano-pipette may be challenging. In general, the meniscus size may depend on a plurality of parameters such as the air humidity, wetting properties of the substrate, retraction speed (e.g., as shown in FIG. 10C), and the like.

Meniscus-confined approaches may be used for the continuous growth of wire-like structures. The synthesis of vertical wires may be achieved with regular glass micropipettes. To produce tilted and horizontal wires, the use of pipettes with custom-shaped apertures may be required to establish and maintain a horizontal meniscus. A FIB milling of individual pipettes may be employed to shape the aperture accordingly (e.g., as shown in FIG. 10D). By using such pipettes, overhanging spirals and horizontal wire bonds were fabricated (e.g., as shown in FIG. 10D). The combination of the controlled evaporation of the meniscus and the application of appropriate potential profiles may allow the growth of hollow tubes.

The reaction rate of electrochemical reactions is limited (e.g., mass transport limited) above a critical potential. At potentials that are too high, side effects such as hydrogen evolution may occur and impede the electrochemical process. As a result, a corresponding fabrication speed is generally relatively low. For example, the growth rate of the copper wires in FIG. 10D is 0.25 μm s-1. of ≈3×10-8 Ωm, which is only 80% higher than the resistivity of bulk copper and indicates the metallic nature of the deposits. Meniscus-confined electroplating may be used for 3D additive methods for copper and platinum as well as two dimensional (2D) patterning of silver.

For scanning ion conductance electroplating (SICM-EP), a double-barrel glass may be immersed in an EC cell, each barrel containing a CE. A first barrel may be filled with the copper salt solution, whereas a second barrel may be filled with a salt solution (e.g., the same as in the bulk of electrolyte and without any metal ions). The second barrel without metal ions may responsible for the SICM feedback during the approach toward the WE, while the first barrel may serve as a source of metal ions to be reduced in the volume between pipette apex and WE. High aspect-ratio structures, together with overhanging ones, could be manufactured, with sections that are 10-20 times larger than that of the aperture (e.g., 30-50 nm). A similar double-channel pipette configuration may be implemented where one channel is assigned to the SICM feedback for the apex-substrate separation, while the other is filled with a gold colloidal solution (3 nm) for electrophoretic deposition of the Au nanoparticles, obtaining high-aspect ratio micropillars with diameter in the sub-micron range (˜800 nm diameter with a nozzle aperture of −200 nm).

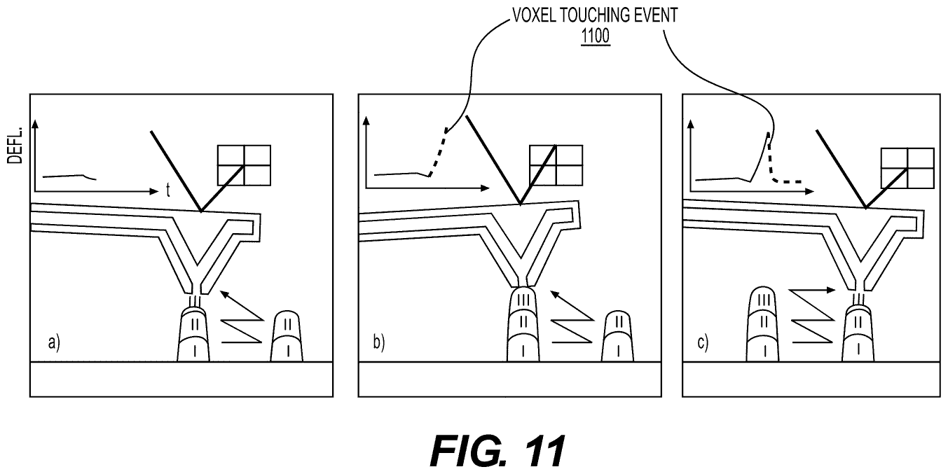

Force-controlled electroplating (FCEP) may use FluidFM technology to combine AFM and microfluidics by means of AFM cantilevers with an embedded microchannel and an aperture at their apex. When used for micro additive methods, these hollow AFM probes may identified as “ion tips”. Upon immersion in a standard three-electrode EC cell, an ion tip could be used as nozzle for local supply of precursor ions (e.g., copper), confining their EC reduction on the cathodically polarized WE. This provides a protocol for 3D micro additive methods of metal structures. By setting an initial separation of a few hundred nanometers between the probe aperture and the substrate, the locally plated metal may freely grow in the vertical direction, creating a voxel and thus giving access to printing in the third dimension. The protocol may be automated by relying on the force-sensing capability by detecting when the growing voxel touches the probe apex. A deflection signal may be used as a trigger to define when the voxel deposition has ended. Subsequently, the probe may be moved to a next coordinate where the following voxel is planned to be deposited. Therefore, complex microstructures may be fabricated in a true layer-by-layer fashion as shown in FIG. 11.

FIG. 11 shows an automated force-controlled EC 3D printing process using a simplified example of two side-by-side pillars. The layer-by-layer fabrication (i.e., labeled layers I-III) is shown. The pillars are printed in parallel and not in series. FIG. 11A shows an ion tip filled with CuSO4 solution that is positioned over the first pillar at a set separation (e.g., 500 nm) where the metal voxel is to be deposited. Local electroplating is switched on at a given overpressure, leading to local pillar growth (i.e., voxel III). FIG. 11B shows that when the growing voxel touches the pyramidal apex, a cantilever deflection is detected on the photodiode via the moving laser beam. The inset graph shown in each of FIGS. 11A, 11B, and 11C shows the temporal evolution of the deflection signal for a voxel touching event 1100 (shown as the bolded segment). FIG. 11B shows that the touching event 1100 is recognized by the software, the probe is moved to the next position on top of the second pillar with a typical separation of 500 nm, and the voxel EC deposition is started at the second pillar.

To enhance the geometric freedom of meniscus-confined electroplating, techniques based on the localized delivery of metallic ions through hollow AFM cantilever in solution may be used. An additional technique based on the same principle but relying on glass capillaries in SICM configuration may also be used.

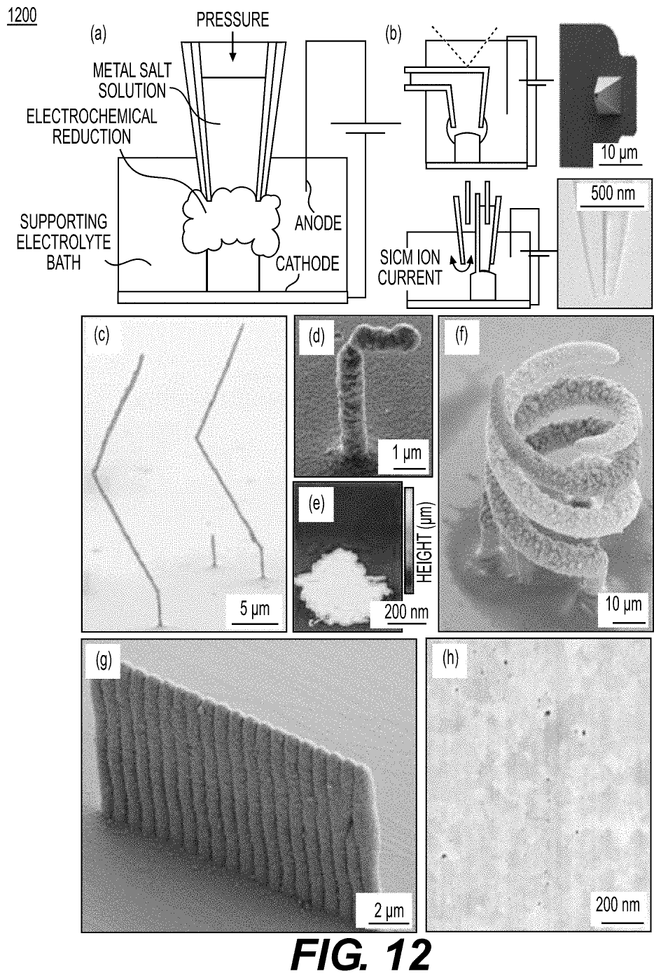

FIG. 12 shows an example 1200 of local dispensing of metal ions in liquid. FIG. 12A shows an illustration of a localized electroplating with a confined concentration field of precursor ions for local dispensing of metal ions in liquid. A nanopipette may serve as a local source of metal ions immersed in an electrochemical cell. The dispensing of a metal salt solution through the pipette may result in a confined concentration field of metal ions. These ions are reduced locally upon the application of a cathodic potential to the substrate. The metal ions exiting an aperture of the cantilever tip may be reduced locally if the cantilever tip is approached to a surface having cathodic potential above a threshold. The threshold may be determined by a system or a user. FIG. 12B shows different feedback mechanisms. The top of FIG. 12B shows a FluidFM system where hollow AFM cantilevers detect the growing deposit via the deflection signal of the cantilever. The bottom of 12B shows a SICM system with dual-barreled pipette. One barrel serves as the metal ion source whereas the ionic current through the other barrel is used for SICM feedback. FIG. 12C shows high aspect ratio structures and FIG. 12D shows an overhanging structure produced with the SICM system. FIG. 12E shows the SICM system that allows for an in situ topography scan (e.g., dual-barreled pipette in FIG. 12B, 12C-E). FIG. 12F shows a triple helix and FIG. 12G shows a copper wall structure fabricated in a layer-by-layer sequence with the FluidFM system. FIG. 12H shows a FIB cross-section of a copper structure deposited with FluidFM. The polycrystalline, mostly dense, nature of the deposit is evident in FIG. 12.

In the example provided in FIG. 12 and the related technique, the metal ions may only be present in the pipette and not in the surrounding solution. The localization of the electroplating reaction may be achieved by spatial confinement of the metal ion supply through the nano-sized pipette aperture. For 3D deposition, the pipette may be brought proximate to a cathodically polarized substrate, usually to a separation of ≈15-500 nm. Subsequently, a controlled dispensing of metal ions from the pipette aperture may be induced. The ions exiting the aperture may be electrochemically reduced on the cathodic substrate, and the localized nucleation and growth of a metal deposit may initiated. A feedback mechanism may be employed to detect the growth of the deposit and to maintain a constant separation between the pipette and the deposit.

Two different setups for the process described above may be applied. These processes may differ based on the pipettes used, as depicted in FIG. 12B. The first setup, called FluidFM may be a variation of on an AFM equipped with cantilevers featuring a fluidic microchannel that ends in an aperture at the apex of the AFM tip. An SEM image of a FluidFM cantilever is shown as an inset in FIG. 12B. Tip openings may be 300 nm and may range from 100 nm to 2 μm. The second setup may be based on SICM and use a dual-barreled glass capillary to dispense the metal ions. Only one of the barrels may be filled with the metal salt solution, while the other barrel may be used for SICM feedback. The aperture diameters of the pulled glass pipettes may be between 30 nm and 50 nm as shown in FIG. 12B.

The pipette and the substrate may both be immersed in a supporting electrolyte bath. A potentiostat may control the potential of the substrate through a reference electrode and a counter electrode placed in the bath. In the case of SICM, an additional electrode may be placed in each barrel where one serves to induce the ion current for the SICM feedback, whereas the other, placed in the barrel with the metal salt solution, may be used to regulate the metal ion flux via electromigration. In contrast, FluidFM may use a pressure controller connected to the FluidFM cantilever for controlled dispensing of the metal ion solution.

In comparison to the SICM, the FluidFM may utilize the force between the tip apex and the substrate in the standard AFM contact-mode as feedback. During the deposition process, the tip may be positioned at a given distance above the substrate. When the growing deposit reaches the tip, pushing against its apex, the respective deflection signal may indicate the successful fabrication of a voxel, whereupon the tip is moved to its next position. In contrast, the SICM setup may be based on the ionic current measured between an auxiliary electrode and an electrode immersed in one of the two barrels of the capillary, and thus may be contactless. This configuration may enable a continuous positioning feedback during deposition and may avoid contact between the deposit and the pipette. As with any electrodeposition process, the choice of the substrate may be limited to conductive or semi-conductive materials.

The absence of a liquid meniscus and the growth in solution may simplify the variation of growth direction. Wire-like structures as shown in FIGS. 12C, 12D, and 12F can be grown at variable angles, and overhangs of more than 90° may been demonstrated. Additionally, without the need to place a liquid meniscus, structures may be built in a non-continuous layer-by-layer fashion. The FluidFM system may show this ability by fabricating walls, as shown in FIG. 12G as well as more complex shapes such as hollow structures or the triple helix as shown in FIG. 12F.

The enhanced geometric freedom may come at the cost of larger feature sizes compared with meniscus-confined electroplating. Because the metal ions are dispensed into the bath surrounding the pipette, the deposits may be generally larger than the aperture size. The smallest deposits produced with a 300 nm FluidFM aperture may have a diameter of ≈800 nm. Pillars fabricated with glass capillaries with openings of 30-50 nm may have diameters of 400-600 nm. In both cases, the structures may typically be slightly broader at their base. Additionally, the surface of printed features can be rough as shown in FIG. 12F, due to the unwanted deposition of diffusing ions onto previously printed structures.

Similar to the meniscus-confined approach, the speed of the process may be limited by the electroplating rate. Thus, the speed may be a function of the applied over-potential and the mass transport conditions. With typical parameters, the wall shown in in FIG. 12G may fabricated in 15 min. The z increment between each layer, i.e., the voxel height, may be approximately 250 nm for FluidFM. Such voxels may be deposited in approximately 0.5 s. However, the growth speed may depend on process conditions, such as the aperture size, liquid flow, and ion concentration. Typical growth speeds of metal structures deposited with the SICM system may be in the range of 20-100 nm s-1.

An FIB cross-section of a FluidFM copper deposit is shown in FIG. 12H. While some pores can be observed, the obtained microstructure is dense and polycrystalline with grain sizes of ≈10-100 nm. Energy-dispersive X-ray spectroscopy may be used to confirm the purely metallic nature of the as deposited structures.

The techniques provided in FIG. 12 may be used with any applicable metal including, but not limited to, the 3D deposition of copper, platinum, copper-nickel alloy were 2D-patterned using regular glass pipettes on a larger scale, or the like.

Electrohydrodynamic redox printing (EHD-RP) may also be applied using double-barrel capillary glasses, each barrel containing solvated metal ions generated via in situ EC dissolution of a metal electrode (e.g., copper and silver). Ion-loaded solvent droplets may then be expelled by electrohydrodynamic forces and reduced to a metal deposit on the WE (e.g., ˜400 nm diameter with a nozzle aperture of ˜200 nm). This technique may allow manufacturing multi-material microstructures.

A microscale multi-metal additive method technique called electrohydrodynamic redox printing (EHD-RP) may be an ink-free technique that overcomes limitations of small-scale multi-material additive method for the case of metals. EHD-RP includes the direct printing and mixing of multiple, high-quality metals from a single nozzle. EHD-RP combines the high spatial resolution of electrohydrodynamic (EHD) printing with the in situ generation and deposition of metal ions from sacrificial anodes. The combination of submicron geometrical feature size and fast modulation of the printed chemistry offers unmatched control of the 3D chemical architecture of printed structures and enables tuning of local properties through local alloying at the submicron scale.

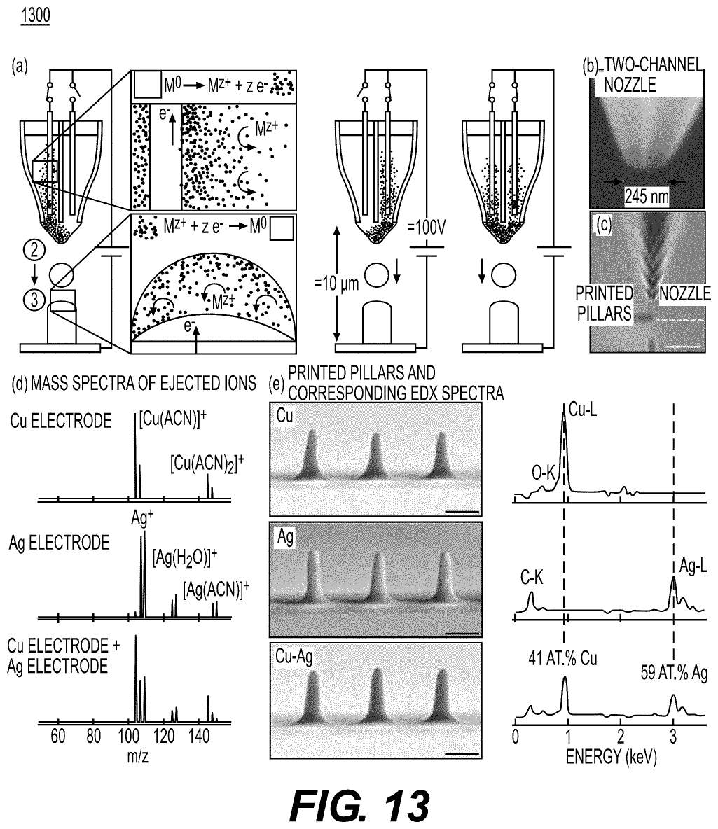

FIG. 13 shows aspects of EHD-RP via example 1300. Solvated metal ions Mz+ may be generated within the printing nozzle via electrocorrosion of a metal electrode MO immersed in a liquid solvent. Ion-loaded solvent droplets may be ejected by electrohydrodynamic forces. Upon landing, Mz+ ions may be reduced to zero valence metal MO through electron transfer from the substrate. Switching the oxidative voltage between different electrodes in a multichannel nozzle may result in on-the-fly modulation of the printed chemistry with typical dimensions of the electrode wire are 100 μm×2 cm, as shown in FIG. 13A. FIG. 13B shows a two-channel nozzle. FIG. 13C shows an optical micrograph of the printing process. The scale bar applied may be 10 μm. At FIG. 13D and FIG. 13E printing Cu, Ag and Cu—Ag from a single, two-channel nozzle is shown. FIG. 13D shows a mass spectra of ejected ions when biasing the Cu electrode, the Ag electrode, or both electrodes immersed in acetonitrile (ACN). At FIG. 13E printed Cu, Ag and Cu—Ag pillars with corresponding energy-dispersive X-ray (EDX) spectra reflecting the chemical nature of the respective source electrode (background subtracted) are shown. The C—K and O—K peaks likely originate from residual solvent and minor oxidation, respectively. The Cu and Ag contents of the Cu—Ag pillars are given in a percentage normalized to the total Cu+Ag signal.

EHD-RP utilizes electrochemistry to synthesize metallic deposits such that in situ dissolution of a metal anode MO immersed in a liquid solvent (e.g. acetonitrile) generates solvated metal ions Mz+ inside the printing nozzle, as shown in FIG. 13A.

The ions Mz+ are ejected towards the substrate, where they are reduced to form the metallic deposit MO. The ion source may be quasi-infinite, as the volume of the anode may be many orders of magnitude larger than the printed volumes. The emission of ions is accomplished by EHD ejection of ion-loaded solvent droplets from the orifice of the printing nozzle. An applied DC voltage of 80-150V may drive the EHD ejection of droplets and at the same time ensures a sufficiently high anodic surface potential for the dissolution of the source electrode. Direct printing onto metallic and semi-conductive substrates as well as indirect printing across insulators may be accessible. The use of sacrificial metal electrodes combined with the localized electrochemical reduction of the generated ions on the substrate may be different than traditional additional method concepts in general. More specifically, this process may be different from previous demonstrations of ink-based EHD micro- and nano-printing of metals. Sacrificial anodes as precursors for metal ions may be used for solution-based synthesis and electrospraying of metal ions and particles. EHD-RP may differ from these processes by using highly localized electrochemical growth of dense materials as well as the continuous modulation of the deposited chemistry, as opposed to the deposition of isolated particles. Multi-metal and alloy printing from a single nozzle may be used as part of an EHD-RP process. EHD-RP may allow simultaneous printing of multiple metals from a single multichannel nozzle, as shown in FIG. 13A. To grow two different metals A and B, a wire of A and a wire of B may each be placed in one of the compartments of a two-channel nozzle. If the positive voltage is applied to one of the wire electrodes only, then only one ion species Δz+ or Bz+ is created and ejected, and A or B is printed. If both electrodes are biased simultaneously, an alloy A-B is deposited. FIG. 13D and FIG. 13E shows this principle for a Cu and an Ag electrode: mass spectra of the ejected ions reflect the elemental nature of the biased electrodes shown in FIG. 13D and energy-dispersive X-ray (EDX) spectroscopy that confirms the corresponding chemical composition of the printed structures at FIG. 13E.

An additional method to achieve fully metallic structures in microscale with submicron accuracy is template-assisted electrodeposition (TAE) in combination with two-photon lithography templates (molds). Such 3D shaped electrodeposited structures may be comprised of a wide range of electrodepositable materials, with size scale spanning from nano to macroscale, and structures can be produced in an additive manufacturing manner without microscale damage induced by subtractive manufacturing, such as micromachining or focused ion beam milling.

The localization of the chemical reaction in the focal point of the laser in two-photon lithography allows for the creation of 3D templates (molds) with submicron accuracy and almost no geometrical restrictions, while electrodeposition offers a high amount of control over the deposits' microstructure, composition and internal stress. The influence of template-assisted electrodeposition, may be addressed using techniques such as such as convection in narrow trenches, template filling ratios, influence of additives on trench filling, and/or macroscale feature density. Various electrodeposition aspects, such local electrolyte concentration, local current density variations, non-homogenous active areas, hydrogen evolution, natural and forced convection interfere with controlled manufacture of 3D micro-architectures with precise geometries and desirable microstructures.

3D template assisted electrodeposition (i.e., electrodeposition inside micro-molds) may include the deposition of a positive tone photoresist (photopolymer) on a conductive substrate and the two-photon polymerization of the 3D Computer Aided Design (CAD) model on the photoresist, where the CAD model touches the conductive substrate. Although CAD and CAD models are generally discussed herein, it will be understood that any computer aided program or model may be used to perform the tasks discussed in relation to CAD and/or CAD models. A developer (solvent) may be applied. As positive tone photoresist may be present, material is degraded by light and the developer may dissolve away the regions that were exposed to light leaving hollow the CAD model that was exposed to light, thus creating the mold. Electrodeposition may be conducted. For example, a three-electrode setup with the conductive substrate as the working electrode may be applied. The sample may be removed from the electrochemical cell and the photoresist (mold) may be removed via sonication in acetone.

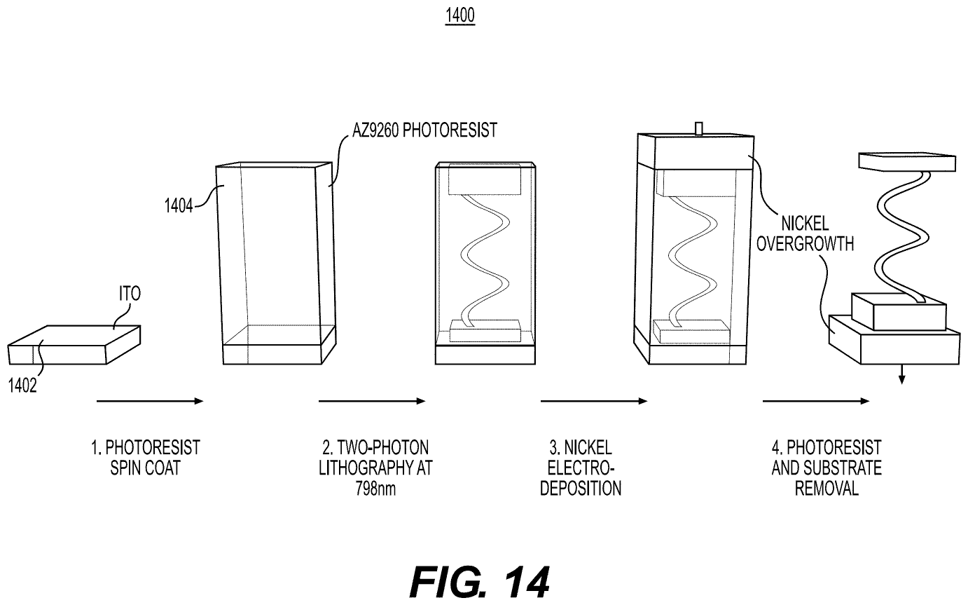

FIG. 14 shows the 3D template assisted electrodeposition as an inversion process 1400 to create nc-nickel micro-springs. At (1) AZ9260 is spin coated onto the Indium tin oxide (ITO) 1402 coated glass substrate. At (2) the pattern is illuminated by two-photon lithography to create the template 1404. At (3) nickel electrodeposition is carried out and an overgrowth is created. At (4) the overgrowth is glued to a SEM stub, the photoresist is removed and the ITO-glass substrate is detached.

Any suitable system infrastructure may be put into place to generate the razor blades, as disclosed herein. Any of the disclosed systems or methods may be executed by or implemented by a computing system. Although not required, aspects of the present disclosure (e.g., as shown in FIG. 4) are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. In a distributed computing environment, program modules may be located in both local and remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures, and techniques have not been shown in detail in order not to obscure an understanding of this description.

While there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

As is evident from the figures, text, and examples presented above, a variety of embodiments may be contemplated including, but not limited to:

1. A method of manufacturing a metallic cutting member, through electrodeposition, the method comprising:

moving a dispenser filled with a metal salt solution to a first printing position;

depositing a metal onto a conductive or semi-conductive substrate via the dispenser until the deposited metal contacts the dispenser; and

upon detecting that the deposited metal contacts the dispenser, moving the dispenser to a second printing position.

2. The method of embodiment 1, further comprising:

receiving a computer aided model of the metallic cutting member; and

loading the computer aided model into a control system.

3. The method of embodiment 2, wherein the computer aided model comprises information of the positions of each of a plurality of voxels corresponding to the cutting member.

4. The method of any of the previous embodiments, further comprising:

inserting the conductive or semi-conductive substrate on a printing chamber; and

immersing the dispenser in a three-electrode electrochemical cell comprising a quasi-reference electrode and a counter electrode.

5. The method of embodiment 4, further comprising aligning the conductive or semi-conductive substrate on the printer chamber.

6. The method of embodiment 4 or embodiment 5, wherein the printing chamber is a macro-electrochemical cell.

7. The method in accordance with any one of embodiments 4-6, wherein the quasi-reference electrode comprises silver and the counter electrode comprises platinum.

8. The method in accordance with any of the previous embodiments, wherein metal salt solution comprises Copper(II) sulfate (CuSO4).

9. The method in accordance with any of the previous embodiments, wherein a flow of the metal salt solution from an aperture of the dispenser is controlled by a pressure controller.

10. The method in accordance with any of the previous embodiments, wherein a dispenser tip is a local source of metal ions in a macro-electrochemical cell comprising a supporting electrolyte.

11. The method in accordance with embodiment 10, wherein the metal ions exiting an aperture of the dispenser tip are reduced locally if the dispenser tip is approached to a surface having cathodic potential above a threshold.

12. The method in accordance with any of the previous embodiments, wherein the dispenser includes an embedded microchannel connecting a hollow tip and a macro reservoir.

13. The method in accordance with any of the previous embodiments, further comprising applying a sputtering process to the metallic cutting member.

14. The method in accordance with any of the previous embodiments, further comprising applying a nano-sharpening process via etching, to the metallic cutting member.

15. The method in accordance with any of the previous embodiments, further comprising applying a lubricating coating to the metallic cutting member.

16. The method in accordance with any of the previous embodiments, wherein the electrodeposition comprises 3D printing, wherein the electrodeposition is one of a) localized by voxel-by-voxel 3D printing to manufacture the metallic cutting member or b) used to manufacture the metallic cutting member through electrodeposition inside a 3D printed polymer mold.

17. The method in accordance with any of the previous embodiments, wherein the dispenser is a cantilever.

18. The method in accordance with any of the previous embodiments, wherein the metallic cutting member is at least one of a blade edge, a blade body, or a blade support.

19. A metallic cutting member of a razor blade formed by the method of any of the previous embodiments.

20. A method of manufacturing a metallic cutting member through electrodeposition, the method comprising:

depositing a positive tone photoresist on a conductive or semi-conductive substrate;

applying a two-photon polymerization according to a metallic cutting member shape defined by a 3D computer aided model of the metallic cutting member to the photoresist;

applying a developer to the positive tone photoresist previously exposed to two-photon polymerization to leave hollow an area corresponding to the metallic cutting member shape;

performing electrodeposition to deposit a metal in the hollow area, to form the metallic cutting member; and

removing the deposited metallic cutting member from the photoresist.

21. The method of embodiment 20, wherein the positive tone photoresist is deposited using one of spin coating, dispensing photoresist on a substrate, or immersing the substrate on the photoresist.

22. The method of any one of embodiments 20-21, wherein the shape defined by the 3D computer aided model of the metallic cutting member is applied to the photoresist such that at least one face of the 3D computer aided model is in contact with the conductive or semi-conductive substrate and at least one other face is in contact with an outer face of the photoresist.

23. The method of any one of embodiments 20-22, wherein the orientation of the shape defined by the computer aided model of the metallic cutting member is one of vertical or horizontal.

24. The method of any one of embodiments 20-23, wherein the developer is a solvent.

25. The method of any one of embodiments 20-24, further comprising exposing the shape defined by the 3D computer aided model to laser beam light.

26. The method of any one of embodiments 20-25, wherein the applying the developer to the 3D computer aided model degrades material of the photoresist that was exposed to the laser beam light.

27. The method of any one of embodiments 20-26, wherein the deposited metallic cutting member is removed from the photoresist via sonication in solvent, wherein the solvent is acetone.

28. The method in accordance with any of embodiments 20-27, further comprising applying a sputtering process to the metallic cutting member.

29. The method in accordance with any of embodiments 20-28, further comprising applying a nano-sharpening process via etching, to the metallic cutting member.

30. The method in accordance with any of embodiments 20-29, further comprising applying a lubricating coating to the metallic cutting member.

31. The method in accordance with any of embodiments 20-31, wherein the electrodeposition comprises 3D printing, wherein the electrodeposition is one of a) localized by voxel-by-voxel 3D printing to manufacture the metallic cutting member or b) used to manufacture the metallic cutting member through electrodeposition inside a 3D printed polymer mold.

32. The method in accordance with any of embodiments 20-33, wherein the metallic cutting member is at least one of a blade edge, a blade body, or a blade support.

33. A cutting member of a razor blade formed by the method of any of embodiments 20-32.

What is claimed is:

1. A method of manufacturing a metallic cutting member, through electrodeposition, the method comprising:
moving a dispenser filled with a metal salt solution to a first printing position;
depositing a metal onto a conductive or semi-conductive substrate via the dispenser until the deposited metal contacts the dispenser; and
upon detecting that the deposited metal contacts the dispenser, moving the dispenser to a second printing position.

2. The method of claim 1, further comprising:
receiving a computer aided model of the metallic cutting member; and
loading the computer aided model into a control system.

3. The method of claim 2, wherein the computer aided model comprises information of the positions of each of a plurality of voxels corresponding to the cutting member.

4. The method of claim 1, further comprising:
inserting the conductive or semi-conductive substrate on a printing chamber; and
immersing the dispenser in a three-electrode electrochemical cell comprising a quasi-reference electrode and a counter electrode.

5. The method of claim 4, further comprising aligning the conductive or semi-conductive substrate on the printer chamber.

6. The method of claim 4, wherein the printing chamber is a macro-electrochemical cell.

7. The method of claim 4, wherein the quasi-reference electrode comprises silver and the counter electrode comprises platinum.

8. The method of claim 1, wherein metal salt solution comprises Copper(II) sulfate (CuSO4).

9. The method of claim 1, wherein a flow of the metal salt solution from an aperture of the dispenser is controlled by a pressure controller.

10. The method of claim 1, wherein a dispenser tip is a local source of metal ions in a macro-electrochemical cell comprising a supporting electrolyte.

11. The method of claim 10, wherein the metal ions exiting an aperture of the dispenser tip are reduced locally if the dispenser tip is approached to a surface having cathodic potential above a threshold.

12. The method of claim 1, wherein the dispenser includes an embedded microchannel connecting a hollow tip and a macro reservoir.

13. The method of claim 1, further comprising applying a sputtering process to the metallic cutting member.

14. The method of claim 1, further comprising applying a nano-sharpening process via etching, to the metallic cutting member.

15. The method of claim 1, further comprising applying a lubricating coating to the metallic cutting member.

16. The method of claim 1, wherein the electrodeposition comprises 3D printing, wherein the electrodeposition is one of a) localized by voxel-by-voxel 3D printing to manufacture the metallic cutting member or b) used to manufacture the metallic cutting member through electrodeposition inside a 3D printed polymer mold.

17. The method of claim 1, wherein the dispenser is a cantilever.

18. The method of claim 1, wherein the metallic cutting member is at least one of a blade edge, a blade body, or a blade support.

19. A metallic cutting member of a razor blade formed by the method of claim 1.

20. A method of manufacturing a metallic cutting member through electrodeposition, the method comprising:
depositing a positive tone photoresist on a conductive or semi-conductive substrate;
applying a two-photon polymerization according to a metallic cutting member shape defined by a 3D computer aided model of the metallic cutting member to the photoresist;
applying a developer to the positive tone photoresist previously exposed to two-photon polymerization to leave hollow an area corresponding to the metallic cutting member shape;
performing electrodeposition to deposit a metal in the hollow area, to form the metallic cutting member; and
removing the deposited metallic cutting member from the photoresist.
